(19) United States
(12) Patent Application Publication
(10) Pub. No.: US 2007/0236027 A1
(43) Pub. Date: Oct. 11, 2007

(54) Measuring scoop

(76) Inventors: James E. Johanson, Old Chatham, NY (US); Keith E. Antal, Valatie, NY (US)

Correspondence Address: IP GROUP OF DLA PIPER US LLP, ONE LIBERTY PLACE, 1650 MARKET ST, SUITE 4900, PHILADELPHIA, PA, 19103, US

(21) Appl. No.: 11/400,147

(22) Filed: Apr. 7, 2006

(51) Int. Cl. G01F 19/00

(52) U.S. Cl. 294/55

(57) ABSTRACT

A scoop is provided having a bowl. The bowl includes a closed end and an opposing open end. An axial handle extends from the closed end of the bowl, along the longitudinal axis of the bowl, away from the bowl. The scoop may include an inclined internal ridge extends along at least a portion of an inner surface of the bowl.

### FIELD OF THE INVENTION

The present invention relates to apparatus for scooping solid particulate material, such as a powder or other granular material.

### BACKGROUND

Containers for handling particulate food material, such as cans of baby powder, coffee or grated cheese, are sometimes supplied with a disposable scoop for dispensing the materials contained therein. Typically, the scoops have an open ended cup positioned at the end of a handle.

Generally, the handles on these scoops are short in relation to the size of the container. Upon opening the container, when a user wants to retrieve a measured amount of material, the first step is to find the scoop. Because of the small size of the scoop, it is likely that the scoop will settle at the bottom of the container, thus forcing the user to reach through the material in the container to dig out the scoop. This procedure is often messy.

In use, the above-described scoop is generally used with a semicircular scooping motion to retrieve material. This may lead to “heaping” of the material above the rim of the scoop, thereby requiring a user to level off the amount of material in the scoop to get a measured amount. This may also be messy and potentially unsanitary.

It would be beneficial to provide an apparatus for scooping material from a container that is easily findable in the container. It would also be beneficial to provide an easy measured scooping of material from the container.

### SUMMARY OF THE INVENTION

The present invention relates to apparatus for scooping measured amounts of material. One aspect of the invention is a scoop comprising a cylindrical bowl having a closed end and an opposing open end. An axial handle extends from the closed end, away from the bowl. The scoop may also have an inclined internal ridge provided around at least a portion of an inner surface of the bowl.

A further aspect of the invention includes a scoop for material comprising a bowl and a handle. The bowl has a longitudinal axis extending therethrough. An open end of the bowl is disposed about the longitudinal axis at a first end and a closed end of the bowl is disposed at an opposing second end. The handle is elongated and extends from the second end, away from the bowl, preferably along the longitudinal axis. The scoop may further include an inclined internal ridge extending around at least a portion of an inner surface of the bowl.

A third aspect of the invention includes a method for scooping material. The method includes providing a scoop having a cylindrical bowl with a closed end and an opposing open end. The scoop has a handle with a longitudinal axis extending from the closed end away from the bowl. Also provided is a quantity of particulate material. The method includes inserting the scoop, open end first, into the material until the material fills at least a portion of the bowl. Finally, the method includes moving the scoop in a shearing direction and removing the scoop from the quantity of material.

### BRIEF DESCRIPTION OF THE DRAWINGS

For the purpose of illustrating the invention, there is shown in the drawings a form that is presently preferred; it being understood, that this invention is not limited to the precise arrangements and instrumentalities shown.

FIG. 1 is a perspective view of a scoop according to an embodiment of the present invention, shown within a container.

FIG. 2 is a cross-sectional view of the scoop shown in FIG. 1.

FIG. 3 is a perspective view of a scoop according to an alternative embodiment of the present invention

FIG. 4 is a cross-sectional view of the scoop shown in FIG. 3.

FIG. 5 is a cross-sectional view of a scoop according to a third embodiment of the present invention.

FIG. 6 is a cross-sectional view of a scoop according to a fourth embodiment of the present invention.

FIG. 7a is a cross-sectional view of the scoop of FIG. 1, being inserted into a container of material.

FIG. 7b is a cross-sectional view of the scoop of FIG. 1, as inserted into material within a container.

FIG. 7c is a perspective view of the scoop of FIG. 1, being withdrawn from a container with scooped material contained therein.

FIG. 7d is a perspective view of the scoop of FIG. 1, shown with a receiving container.

### DETAILED DESCRIPTION OF THE DRAWINGS

In the figures, where like reference numerals indicate like elements, there is shown an embodiment of a scoop, generally identified by the numeral 10. The scoop 10 is used to scoop particulate materials, such as baby powder, grated cheese, coffee and other powders or granular materials, from containers 12. The directions up and down, as well as top and bottom, respectively refer to those directions as shown in the Figures. The term longitudinal refers to a direction extending from the top to the bottom of the scoop 10.

The scoop 10 has a generally cylindrical bowl 14 and an elongated handle 28. The bottom of the bowl 14 comprises an open end 16, defining a generally cylindrical opening. A cylindrical wall 18 extends along a longitudinal axis upwardly from the open end 16. The top of the bowl is a closed end 20, defining the opposing terminus of the cylindrical wall 18 from the open end 16. The closed end 20 has a generally planar central section 22 that is perpendicular to the axis of the cylindrical wall 18 and rounded edges 24 that define the transition between the cylindrical wall 18 and the central section 22. A vent 26 extends through the closed end 20 of the bowl 14. The vent 26 serves to allow air to escape from the bowl when the scoop 10 is inserted into a quantity of material thereby minimizing the risk that trapped air inside of the bowl 14 will restrict the scooping of material. The bowl 10 is sized to contain a predetermined amount of material. By way of example, the bowl 10 could have an interior volume of two fluid ounces. Although a cylindrical bowl 14 is shown here, the bowl 14 may have any profile, such as a square, triangular or some other polygonal shape, without departing from the scope of the present invention.

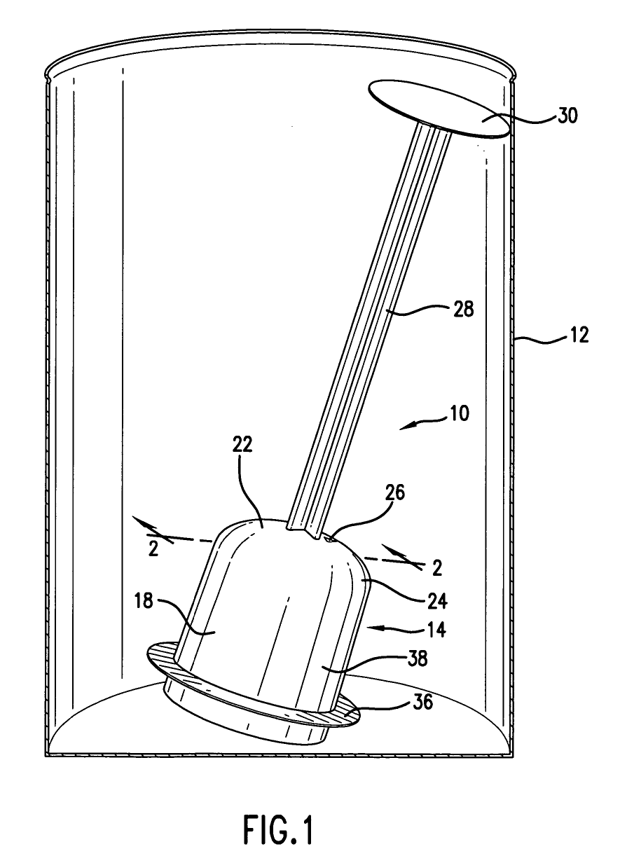

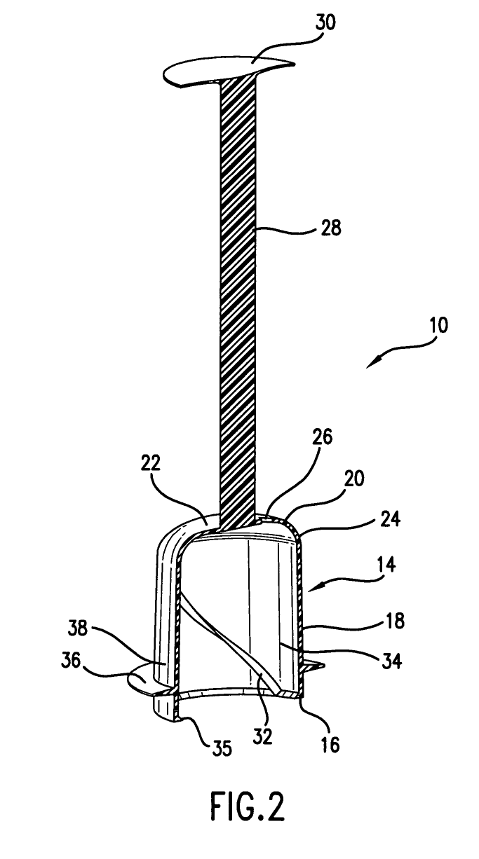

The handle 28 extends longitudinally from the closed end 20 of the bowl 14 away from the open end 16. The handle 28 is generally coaxial with the cylindrical wall 18. The handle 28, as shown in FIGS. 1 and 2, is has an “+” shaped cross section and a gripping disc 30 located at the opposite end of the handle from the bowl 14. The disc 30 is generally perpendicular to the axis of the handle 28 and preferably has a width that is slightly smaller than that of the bowl 14. The disc 30 may also have any other geometric or ergonomic shape without departing from the scope of the present invention.

Preferably, an inclined internal ridge 32 extends along an inner surface 34 of the bowl 14. The ridge 32 begins at the open end 16 of the bowl 14 and extends around the cylindrical wall 18 and towards the closed end 16. The ridge 32 may be helical, spiral or some other direction that extends both circumferentially and longitudinally along the inner surface 34 of the bowl 18. The ridge 32 serves to engage material inside the bowl 14, further helping to retain the material therein, when the scoop 10 is in use. In addition to the internal ridge 32, an internal circumferential ring 35, such as an undercut or other structure may be disposed along the inner surface 34, proximate the open end 16, to further retain material inside of the bowl 14.

Preferably, an external protrusion, such as a circumferential ring 36 extends around an outer surface 38 of the cylindrical wall 18. The ring 36 is located closer to the open end 16 of the bowl 14 than to the closed end 20. The ring 36 extends radially away from the cylindrical wall 18 an is preferably taller than it is thick, as best seen in FIG. 2. In use, the ring 36 serves as a tapping surface to allow a user to empty the contents of the scoop 10 into a container (not shown), such as a bottle, by-tapping the ring 36 onto the rim of the bottle by using a motion that is downward along the axis of the handle 28 and the bowl 14. Although a ring 36 is shown, any other suitable protrusion, extending from the outer surface 38 of the bowl 14, may serve the same purpose of restricting insertion of the scoop 10 too far into a receptacle.

As shown in FIG. 1, the scoop 10 is sized to be used in connection with a container 12, such as a can, so that at least a portion of the scoop 10 is disposed near the top of the container when the scoop 10 is disposed therein. This eliminates the need for a user to sift through any material in the container 12 to retrieve the scoop 10.

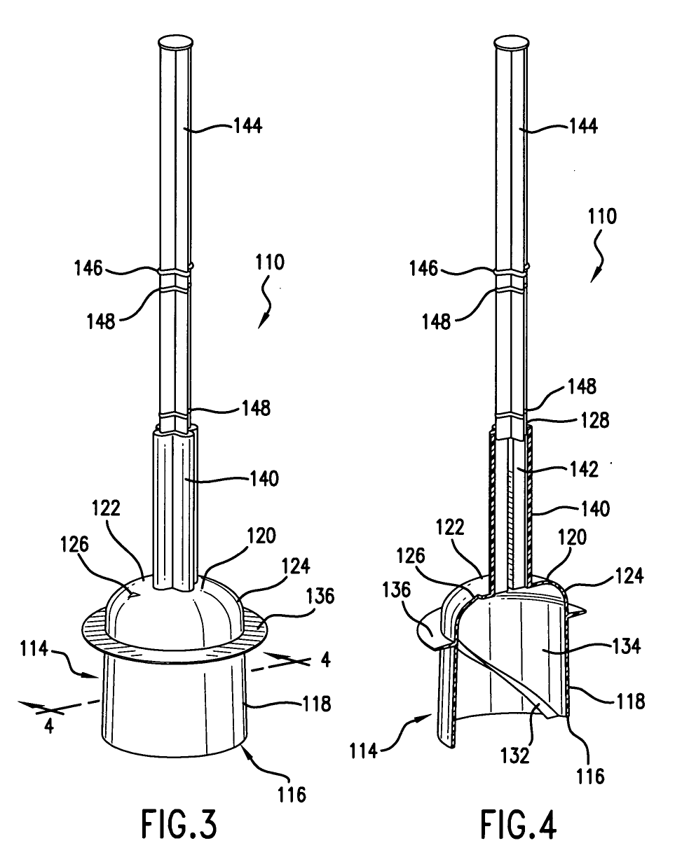

An alternative embodiment of a scoop 110 in FIGS. 3 and 4. The scoop 110 has many of the same features as the scoop 10. These features include a bowl 114 having an open end 116, a closed end 120 and a cylindrical wall 118 extending therebetween. The closed end 120 has a generally planar center section 122 that is perpendicular to the longitudinal axis of the cylindrical wall 118 and rounded edges 124 that define the transition between the cylindrical wall 118 and the closed end 120. A vent 126 extends through the closed end 120.

Like the scoop 10, an inclined internal ridge 132 extends about an inner surface 134 of the bowl 114. A circumferential ring 136 is located on an outer surface 138 of the cylindrical wall 118 and extends radially therefrom, like the ring 36.

A handle 128 extends from the closed end 120 of the bowl 114 in a direction that is coaxial with the cylindrical wall 118 and away from the open end 116. The handle 128 is telescopic, having a first portion 140 extending from the closed end 120. The first portion 140 has an internal longitudinal passageway 142 that preferably matches the outer profile of the first portion 140, such as the “+” shaped profile shown in FIGS., 3 and 4. The passageway 142 extends from the bowl 14 through the entirety of the first portion 140. The handle 128 also has an elongated second portion 144 that slidably fits within the passageway 142. A central rib 146 is located along the middle of the second portion 144 and is sized to restrict the second portion 144 from sliding entirely through the first portion 140, into the bowl 114; although a portion of the second portion 144 may be permitted to enter the bowl 114. Accordingly, the central rib 146 is larger than the passageway 142. Retaining ribs 148 are disposed along the second portion 144 between the central rib 146 and the bowl 114. The retaining ribs 148 are sized to frictionally engage the internal surface of the passageway 142 and help the handle remain in an extended position. Alternatively, the handle 128 may have a first portion, attached to the bowl 114, that has the “+” shaped profile of the second portion 144. In such a case, the second portion fits slidably about the first portion in order to allow telescopic expansion of the handle 128.

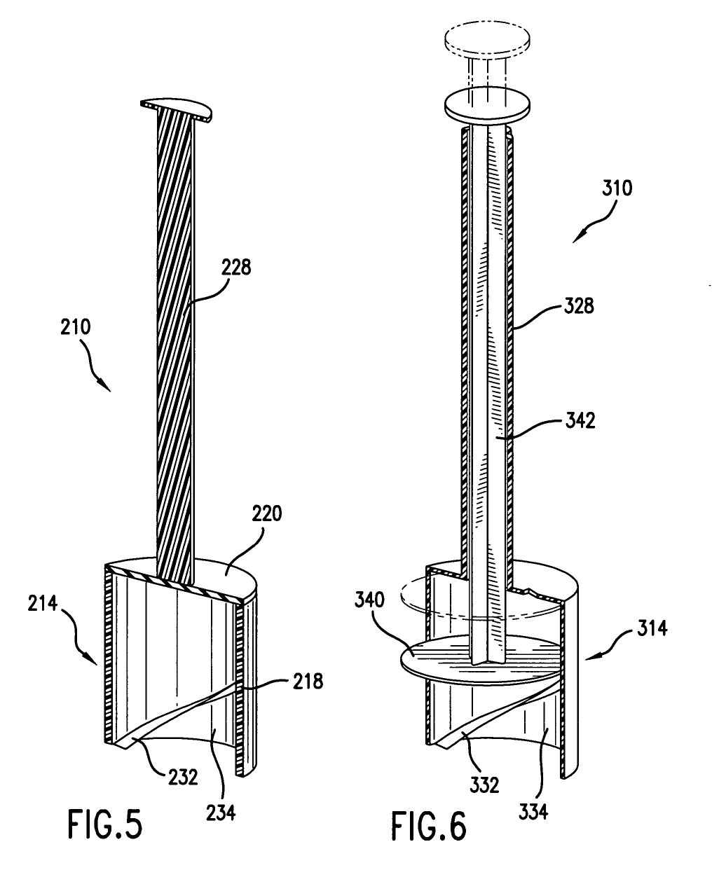

FIG. 5 shows a third embodiment of a scoop 210 having a handle 228 and a bowl 214, defined by a cylindrical sidewall 218 and a cylindrical top member 220. An inclined internal ridge 232 extends about at least a portion of an inner surface 234 of the bowl 214. The top member 220 is preferably constructed from a flexible material such as a flexible plastic, rubber, silicone or some other elastomeric material. Alternatively, the top member 220 may be constructed from the same material as the rest of the scoop 210 and have a flexible construction. The flexible construction may be the result of weakening notches, reduced thickness or some outer suitable construction that will allow longitudinal movement of the handle relative to the sidewall 218.

FIG. 6 shows a fourth embodiment of a scoop 310 having a handle 328 and a bowl 314. An inclined internal ridge 332 extends along a portion of an inner surface 334 of the bowl 314. The scoop has a plunger disc 340 disposed in the bowl 314. The disc 340 is longitudinally operable within the bowl 314 by applying upward and downward forces to a plunger handle 342 that is connected to the disc 340 and extends through the handle 328. Although a disc 340 that spans the entire width of the bowl 314 is shown, the disc 340 may be constructed smaller or notched to clear the internal ridge 332.

In use, the scoop 10 is inserted, open end first, into a quantity of material using an axial motion. Preferably, sufficient pressure is exerted on the scoop 10 to propel the scoop through the material until the bowl 14 is filled with a predetermined amount of material. Upon the filling of the bowl 14 with material, forces inside the bowl 14 that result from pressing it into the material serve to compressively and frictionally retain the material therein. This result is most effectively achieved when the scoop 10 is used with particulate materials that sufficient frictional properties to be retained in the bowl 14 then the bowl 14 is inverted. These materials may also be compressible, thereby exerting outward pressure on the bowl 14 and increasing the effect of its frictional properties. Such materials preferably have cohesive properties which facilitate their clinging together within the scoop as it is pressed into a quantity of the material. By way of example, the scoop may be used with food materials such as spices, baby formula powder, coffee, grated cheese or any other particulate or granular material. Additionally, the scoop 10 may be used with any type of material that has similar properties, including gelatinous and solid materials.

After filling the bowl 14 with material, the scoop 10 is moved in a shearing direction. The shearing direction includes a direction of movement that will serve to shear the material contained within the bowl 14 from any material that is not to be scooped. The shearing direction may include twisting the scoop 10, moving it laterally (i.e. in a direction that is parallel to the opening defined by the open end of the bowl), pivoting the scoop about an axis that is perpendicular to the longitudinal axis of the scoop 10 or any other movement that serves to shear the material in the bowl 14 from material that is disposed below the open end 16 of the bowl 14 after the bowl 14 is inserted into the material.

The scoop 10 is then removed from the material, having a predetermined quantity of material retained therein. The material is released from the bowl 14 by shaking the scoop or impacting the scoop on a rigid object. It is preferable that the entirety of the scooped material is dispensed into a same receiving container 50, while minimizing spillage. In such instances, the receiving container preferably has an annular mouth with a circumference that is greater than that of the open end of the bowl 14 but less than the outer edge of the circumferential ring 36, such as that on a bottle. Then, the open end 16 of the bowl 14 could be inserted into the mouth of the receiving container and the scoop 10 could be shaken or tapped on the receiving container to facilitate the release of the material from inside of the bowl 14.

In use, the flexible top surface 220, shown in FIG. 5, allows a user to apply suction forces, by pulling the handle 228 upwards, to material within the bowl 214 while withdrawing the bowl 214 after scooping the material. This serves to further retain the material within the bowl 214 during the scooping process. At discharge, a user may apply downward force to the handle 228, thereby forcing the top surface 220 to contact the contained material and press it out of the bowl 214. While it is preferable that the top surface 220 does not move along the entire length of the bowl 214, a slight downward movement is generally sufficient to dislodge the material in the bowl 214 and allow the material to succumb to gravity and fall into a discharge receptacle.

In use, the scoop 310 shown in FIG. 6, is operated like the scoop 10, with the additional movement of the plunger disc 340 via the plunger handle 342. During discharge of the material into a receiving container, the user can apply downward pressure to the plunger handle 328 to force the plunger disc 340 against the contained material, thereby releasing the compressive and frictional forces that are retaining the material in the bowl 314 and allowing it to fall into the receiving container.

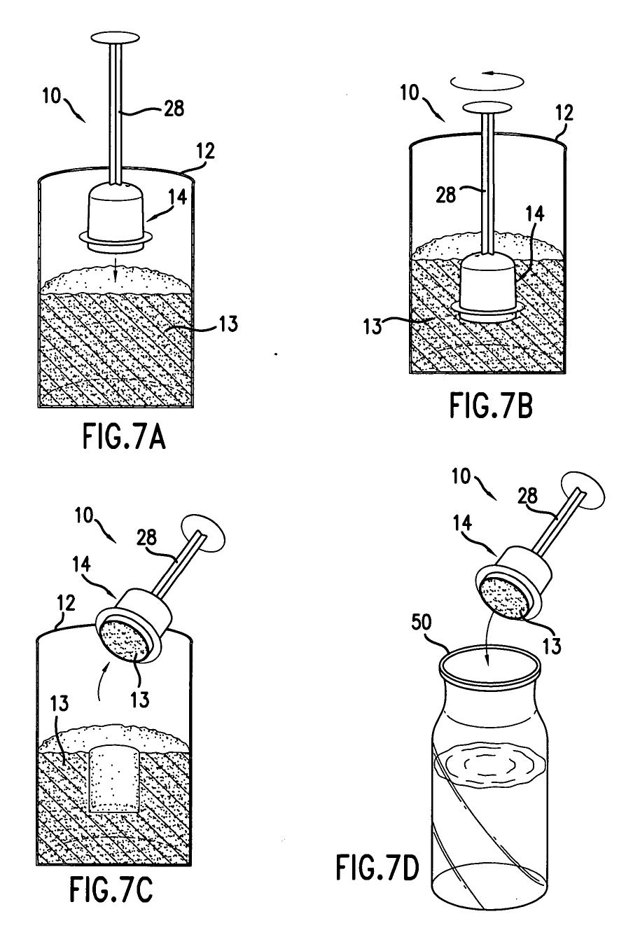

FIGS. 7a-7d show the scoop 10 of FIG. 1 in use. FIG. 7a shows the scoop 10 being inserted into a container 12 of material 13 using an axial thrusting motion. FIG. 7b shows the scoop 10 being moved in a shearing direction. The particular movement shown in FIG. 7b is a twisting motion about the longitudinal axis of the scoop 10 however other motions, as described above, may be used to shear the contents of the scoop from material 13 to be left in the container 12. FIG. 7c shows the scoop 10 being withdrawn from the container 12, with material inside of the bowl 14. The material 13 is then dispensed into the receiving container 50, as shown in FIG. 7d.

A variety of modifications to the embodiments described will be apparent to those skilled in the art from the disclosure provided herein. Thus, the invention may be embodied in other specific forms without departing from the spirit or essential attributes thereof and, accordingly, reference should be made to the appended claims, rather than to the foregoing specification, as indicating the scope of the invention.

What is claimed is:

1. A scoop comprising:
a cylindrical bowl having a closed end, an opposing open end and a bowl wall extending therebetween; and
an axial handle extending from the closed end away from the bowl.

2. The scoop according to claim 1, further comprising an inclined internal ridge extending around at least a portion of an inner surface of the bowl.

3. The scoop according to claim 1, further comprising an external protrusion extending about at least a portion of an outer surface of the cylindrical bowl.

4. The scoop according to claim 1, further comprising an internal circumferential ring disposed about an inner surface of the bowl proximate the open end.

5. The scoop according to claim 1, wherein the handle is expandable.

6. The scoop according to claim 1, further comprising a vent disposed on the closed end of the bowl.

7. The scoop according to claim 1, the bowl further comprising an axially movable upper internal surface.

8. The scoop according to claim 7, wherein the axially movable upper internal surface comprises a flexible membrane that defines the closed end of the bowl.

9. The scoop according to claim 7, wherein the axially movable upper internal surface comprises a plunger that is operable within the bowl.

10. The scoop according to claim 1, wherein the inclined internal ridge comprises a helical ridge.

11. The scoop according to claim 1, the bowl further comprising a longitudinal axis that extends generally perpendicularly to the closed end, wherein the internal ridge extends at an angle with respect to the longitudinal axis.

12. A scoop for material comprising:
a bowl having a longitudinal axis extending therethrough, an open end disposed about the longitudinal axis at a first end of the bowl and a closed end disposed about the longitudinal axis at an opposing second end of the bowl; and
an elongated handle extending from the closed end, away from the first end, along the longitudinal axis.

13. The scoop according to claim 12, further comprising an inclined internal ridge extending along at least a portion of an inner surface of the bowl.

14. The scoop according to claim 12, wherein the bowl is generally cylindrical.

15. The scoop according to claim 12, further comprising an external ridge disposed about an outer surface of the bowl.

16. A method for scooping material comprising:
providing a quantity of particulate material and a scoop having a cylindrical bowl with a closed end and an opposing open end, a handle having a longitudinal axis extending from the closed end away from the bowl;
inserting the scoop, open end first, along the longitudinal axis of the handle into the particulate material until the particulate material fills at least a portion of the cylindrical bowl;
moving the scoop in a shearing direction; and
removing the scoop from the quantity of particulate material.

17. The method according to claim 16, wherein moving the scoop in a shearing direction comprises a movement selected from the group consisting of: twisting the scoop, laterally moving the bowl, and pivoting the scoop about an axis that is perpendicular to the longitudinal axis.

18. The method according to claim 16, the scoop further comprising an inclined internal ridge extending about at least a portion of an inner surface of the cylindrical bowl, wherein the scoop is inserted at least far enough for the inclined internal ridge to engage the particulate material.

19. The method according to claim 16, further comprising the step of dispensing scooped material from the scoop.

20. The method according to claim 19, wherein the step of dispensing the scooped material comprises applying a longitudinal force on the handle, towards the bowl.

21. The method according to claim 19, the scoop further comprising a plunger, wherein the step of dispensing the scooped material comprises pressing the plunger towards the open end of the bowl.
